(19) United States
(12) Patent Application Publication
(10) Pub. No.: US 2006/0088469 A1
(43) Pub. Date: Apr. 27, 2006

(54) Method for preparation and activation of multimetallic zeolite catalysts, a catalyst composition and application for n2o abatement

(75) Inventor: Javier Perez-Ramirez, Tarragona (ES)

Correspondence Address: WENDEROTH, LIND & PONACK, L.L.P., 2033 K STREET N. W., SUITE 800, WASHINGTON, DC, 20006-1021, US

(73) Assignee: Yara International ASA, Olso (NO)

(21) Appl. No.: 10/535,989

(22) PCT Filed: Nov. 25, 2002
(86) PCT No.: PCT/NO02/00439

§ 371 Date: Jul. 8, 2005

(51) Int. Cl. B01D 53/86; C01B 39/02

(52) U.S. Cl. 423/701; 423/239.2

(57) ABSTRACT

The present invention relates to the preparation and activation of multimetallic zeolites loaded with transition metals for N₂O abatement in tail-gases from different sources. The N₂O-containing gas is brought in contact with a catalyst comprising Fe and a second, third, or any additional transition metal (Cu, Co, Ni, Mn, Cr, V), with a total metal content ranging from 0.1-1.0 wt. %, on a zeolite support (MFI or BEA) at 523-873 K. Not 10 only the combination and loading of metals, but also the method of incorporation in the zeolite and its activation is essential to obtain active and stable catalysts. The synergy between metals was observed in Fe—Cu, Fe—Co, and Fe—Co—Cu systems, but not with combinations of iron with other transition metals. The optimal catalysts show high N₂O conversions (>80%) at temperatures <623 K and stable behaviour for >2000 hours in pilot-scale tests with a zeolite-coated monolithic reactor.

The invention concerns a method for preparation and activation of multimetallic zeolite catalysts and application of these for N₂O abatement.

### FIELD OF THE INVENTION

The present invention relates to environmental systems to control emission of pollutants and, more particularly, to catalytic processes to abate nitrous oxide in industrial (chemical production) and combustion sources. The characteristics of the tail-gas are: diluted N₂O streams (in the range of 0.05-0.5 vol. %), relatively low temperature (<800 K), and in the presence of catalyst inhibitors.

### DESCRIPTION OF THE PRIOR ART

Nitrous oxide has been long considered as a relatively harmless species and has suffered from a lack of interest from scientists, engineers, and politicians. However, during the last decade a growing concern can be noticed since N₂O is a strong greenhouse gas (310 times more effective than CO₂) and also participates in the ozone layer depletion. N₂O emissions that can be reduced on the short term are associated with chemical industry and combustion processes. Different options for N₂O abatement in tail-gases have been proposed but no mature technology exists as yet. Although there are numerous papers and patents regarding catalytic systems for direct N₂O decomposition and N₂O reduction with hydrocarbons, laboratory results often deviate from what is normally met within industrial practice, and tests in pilot scale are hardly available. Furthermore, stability tests under realistic conditions have not been taken into consideration.

A novel process for N₂O control in tail-gases of adipic acid plants (N₂O concentration of 25-40 vol. %) consists of the reuse of N₂O as selective oxidant in the reaction of benzene to phenol over Fe-MFI zeolites (U.S. Pat. No. 5,672,777, U.S. Pat. No. 5,110,995). However, this option is impractical in “diluted” tail-gases from other sources (N₂O concentration in the 0.05-0.5 vol. % range).

Several patent applications have recently dealt with co-addition of reducing agents (e.g. light hydrocarbons and ammonia) to the feed mixture for selective catalytic N₂O reduction over ion-exchanged Fe-MFI zeolites, WO 9949954 and WO 0151182. However, this option is not attractive for stationary sources due to the high cost of the reductant and the emissions involved (slip or undesired combustion products).

Direct catalytic decomposition of N₂O is an attractive and economical option to reduce N₂O emissions. However none of the catalysts proposed in the literature show a good activity and stability in N₂O conversion under realistic conditions of feed composition, temperature, and space velocities (Centi et al. ChemTech 29 (1999) 48, Kapteijn et al. Appl. Catal. B. 9 (1996) 25). Transition (Cu, Co, Ni) and noble metal-based catalysts (Rh, Ru, Pd) on different supports (ZnO, CeO₂, Al₂O₃, TiO₂, ZrO₂, or calcined hydrotalcites) are very active for N₂O decomposition in N₂O/He feeds, but the presence of other gases in the feed (O₂, NOₓ, H₂O, SO₂) leads to strong inhibition and/or deactivation.

Many metal-loaded zeolites, including Cu- and Co-ZSM-5, as well as noble-metal based (Rh, Ru, and Pd) show a much higher activity than Fe-ZSM-5 for N₂O decomposition in a N₂O/He feed (F. Kapteijn et al., Stud. Surf. Sci. Catal. 101 (1996) 641 , Li and Armor, Appl. Catal. B. 5 (1995) L257), but in the presence of O₂, NO, and H₂O iron systems are superior (Pérez-Ramfrez et al., Chem. Commun. (2001) 693 and Appl. Catal. B. 35 (2002) 227). This is due to (i) the poor hydrothermal properties of the former metals, (ii) the formation of stable surface nitrate or sulfate-groups in the presence of NO or SO₂, respectively, and (iii) the sintering of active sites under reaction conditions (feed composition and temperature).

Fe-zeolites (mainly MFI but also MOR, BEA, FER) are interesting catalysts because N₂O conversion shows anomalous behaviour in the presence of typical tail-gas components compared to other catalytic systems. A recent patent application, WO 9934901, claims a high activity of Fe-ferrierite in direct N₂O decomposition in wet streams, but space velocities used were relatively low (10,000 h⁻¹) and no durability tests were reported. In WO 0151415, ion-exchanged Fe-zeolites are also used for direct N₂O decomposition in tail-gases of nitric acid plants. Pérez-Ramfrez et al. Catal. Today 76 (2002) 53, have concluded that the preparation route of Fe-ZSM-5 determines the catalyst performance. Steam-activated Fe-ZSM-5 showed much higher activities in direct N₂O decomposition than Fe-ZSM-5 catalysts prepared by other methods (liquid and solid ion-exchange and sublimation). Complete N₂O conversion was achieved in simulated tail-gases of nitric acid plants (at 60,000 h⁻¹) at temperatures >750 K. This temperature is too high for some tail-gas applications, in particular in the tail-gases of chemical production processes. Addition of C₃H₆ reduced the operation temperature of the catalyst by 100 K, but this option remains economically unfeasible.

Developing multimetallic zeolite systems may lead to synergy effects between metals affecting the net activity and stability of the formulation. In a previous patent (U.S. Pat. No. 5,110,995), the remarkable activity and selectivity of iron-zeolites for the selective oxidation of benzene to phenol using N₂O as the oxidant was reported. Fe-ZSM-5 was prepared by conventional hydrothermal synthesis and before reaction the material was calcined in the range of 793-823 K. In some cases, the iron zeolites also contained a second transition metal, e.g. Co, V, Cr, Ni, Mo, introduced in the catalyst by conventional ion-exchange or impregnation.

From the activity results shown in the patent, it can be concluded that the sole presence of iron gives a higher activity and selectivity and that the second metal has no positive effect (but instead slightly negative) on important reaction parameters, like benzene conversion and phenol selectivity. In a more recent application by the same inventors (U.S. Pat. No. 5,672,777 and Re. 36856), it was reported that a significantly improved performance in the benzene-to-phenol process was obtained after hydrothermal treatment of Fe-MFI using a gas containing 3-100 vol. % H₂O in N₂ at temperatures of 773-1273 K. In view of the vain effect of the second transition metal reported in the first patent, they were excluded of the formulation (and patent claims) of the last application.

### OBJECT OF THE INVENTION

The principal object was the development of multimetallic zeolite catalysts for direct nitrous oxide (N₂O) decomposition into nitrogen (N₂) and oxygen (O₂).

Thus, major emphasis is focused on the achievement of formulations showing a high N₂O-decomposition activity at low temperature (<623 K).

Another object was that the catalyst should be stable and retain its activity for >2000 hours under realistic conditions of feed composition (with inhibitors like NOₓ, H₂O, O₂, and SO₂).

A further objective was to produce catalyst systems that could be applied at high gas-hourly space velocities, >50,000 h⁻¹.

It is also an essential objective to arrive at a method for reducing the amount of nitrous oxide from processes where nitrous oxide is formed, e.g. in the chemical production (nitric acid, adipic acid, caprolactam, acrylonitrile, glyoxal, and in general processes using nitric acid as oxidizing agent or involving ammonia oxidation) and combustion processes (of coal, biomass, and waste in fluidised-bed combustors), as well as in any reactions, in which removal of N₂O is required.

These and other objects of the invention are obtained with the method and use as described below, and the invention is further defined and characterised by the accompanying patent claims.

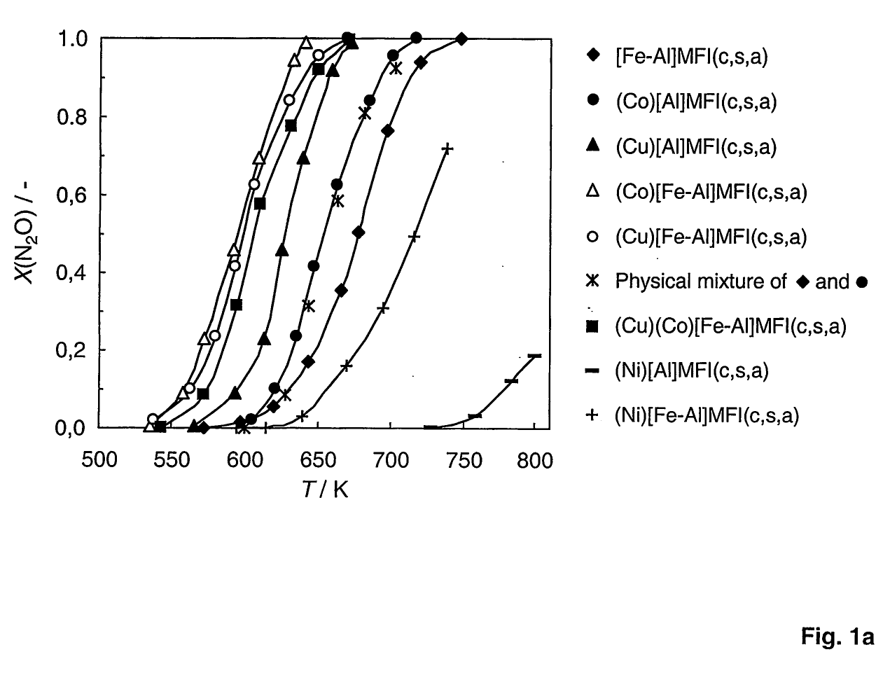

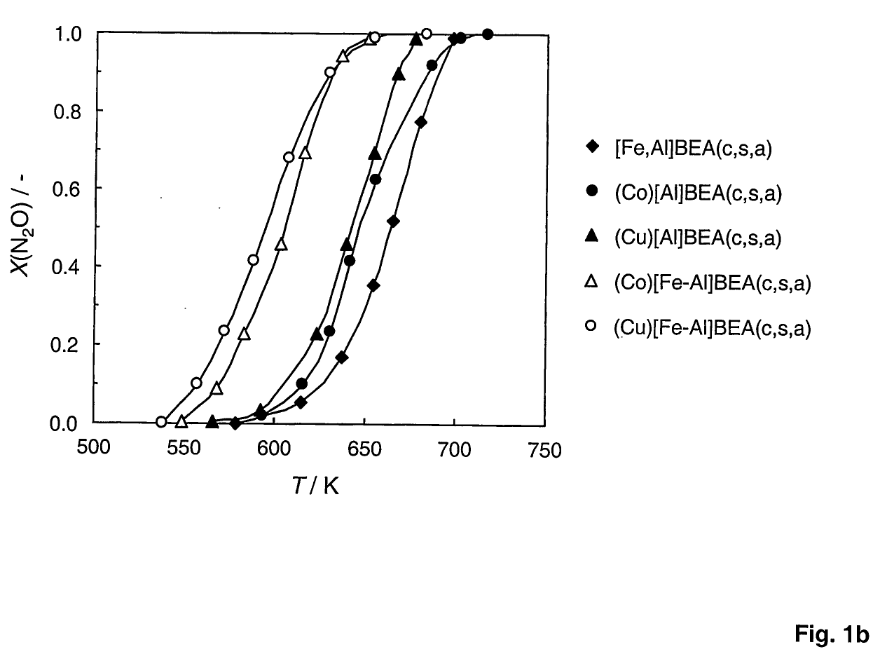

The invention will be further explained with reference to the accompanying drawings, FIGS. 1-3, wherein

FIG. 1. shows N₂O conversion vs. temperature over different mono- and multimetallic zeolites with (a) MFI and (b) BEA structure.

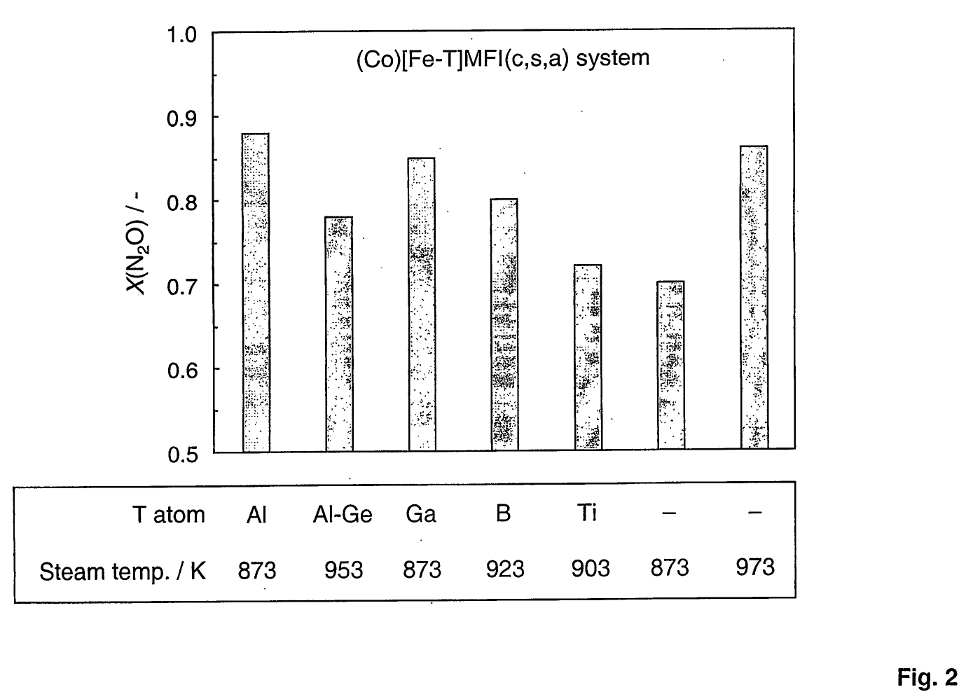

FIG. 2. shows N₂O conversion over (Co)[Fe-T]MFI(c,s,a) zeolites with MFI structure and different framework composition (determined by the T atom used); Nomenclature (c,s,a) denote treatments of the catalyst before reaction: c=calcination, s=steaming, a=alkaline treatment.

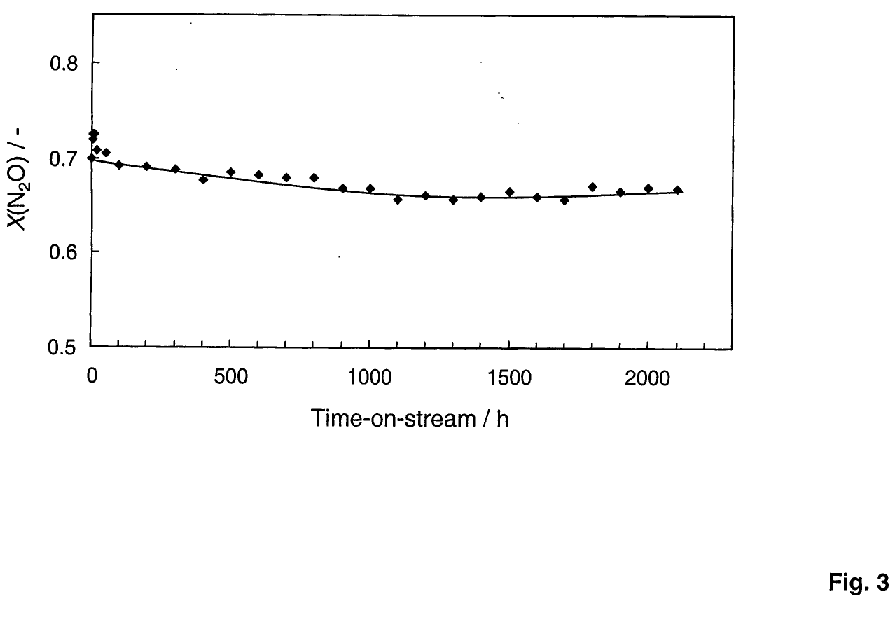

FIG. 3. shows N₂O conversion vs. time-on-stream over (Co)[Fe—Al]MFI(c,s,a) in pilot-scale experiments.

The original idea of the invention was to combine the high activity of Cu and Co-zeolites in N₂O decomposition with the remarkable stability and resistance to poisons of Fe-zeolites in a single multimetallic catalyst. The method of incorporation of the metals in the zeolite structure and its activation is crucial to obtain active formulations at low temperature and that are stable in tail-gas applications.

The invention thus concerns a method for production of a multimetallic zeolite wherein Fe is isomorphously substituted in the zeolite framework by hydrothermal synthesis. The zeolite, in the Na-form, is thereafter calcined and exchanged with an ammonium salt, whereafter Cu and/or Co is introduced by ion exchange before the product is calcined, activated at high temperature in vacuum or air or by steam treatment, and finally subjected to an alkaline treatment. One or more of the elements Mn, V, Ni or Cr could be introduced into the zeolite in addition to Co and/or Cu. Both liquid and solid-ion exchange can be used to introduce the second, third, or any additional metal. The zeolite catalyst can have a structure analogous to MFI and/or BEA. Preferably, the zeolite used is [Al]-ZSM-5, [Al]-BEA, [Ga]-ZSM-5, [B]-ZSM-5, [Ge,Al]-ZSM-5, silicalite or [Ti]-silicalite. It is preferred that the molar Si/T ratio is 20-80, where T=Al, Ga, B, Ge or Ti.

The iron content introduced in the materials ranges from 0.1-1.0 wt. % Fe. The content of Cu and/or Co ranges from 0.1-1.0 wt. %. The preferred zeolite catalysts for the required applications are Fe—Co, Fe—Cu or Fe—Co—Cu zeolites. It is preferred that the metal molar ratio of Fe/Co, Fe/Cu or Fe/Co+Cu≈1. The activation of the zeolite is carried out with water vapour at 623-1273 K, 3-100 vol. % H₂O, at 3-300 ml inert gas (STP) min⁻¹ during 0.5-6 hours. It is also possible to carry out this treatment in vacuum or air at temperatures above 1073 K. The alkaline treatment is carried out in an alkaline medium (NaOH, KOH, or NH₄OH) at 298-363 K, preferably for 10-60 min. Solutions with a concentration ranging from 0.1-1.0 M were used.

The invention also provides a process for the conversion of nitrous oxide (N₂O) into nitrogen (N₂) and oxygen (O₂) using multimetallic zeolites (MFI and BEA), based on transition metals. The invention also concerns a zeolite catalyst and a method for decomposition or reduction of nitrous oxide at temperatures below 623 K in tail-gases by use of the zeolite with the general formula:
x·T₂Oₚ-y·Fe₂O₃-z·M₂O_{q}-SiO₂
wherein:

x=0-0.065

y=0.00002-0.02

z=0.00002-0.02

T=Al, Ga, B, Ge or Ti

p=valence of the T element

M=Cu, Co, Mn, V, Ni, Cr

q=valence of the M element

### DETAILED DESCRIPTION OF THE INVENTION

Initially several iron-loaded multimetallic zeolite catalysts were synthesized using different preparation methods. Tests show that the combination of metals and loadings, and method of incorporation of these metals in the zeolite strongly influences the performance of the final catalyst.

For incorporation of iron, the following methods were applied: hydrothermal synthesis, solid and liquid ion-exchange, and impregnation. The second (and third) metal has been incorporated by (liquid or solid) ion-exchange or impregnation. Consecutive or simultaneous ion exchange or impregnation methods for metals incorporation have been applied. Iron is mandatory in the formulation to obtain good catalytic properties, as well as the second, third, or any additional transition metal. Zeolites with combinations of Fe with Co and/or Cu and prepared by a detailed procedure have shown synergy in catalytic N₂O decomposition. This synergy results in a remarkable activity at low temperature and stability on stream.

Activation of the as-synthesized multimetallic zeolites is crucial to achieve the required catalyst performance. In the steam treatment, the temperature, steam content, and carrier gas have been optimized. Steam treatment in Ar at 873 K proves to be an effective treatment compared to other treatments (at higher temperatures in vacuum or air). A final alkaline treatment is essential to enhance the activity of the zeolites in the low-temperature range. Optimization of this post-synthesis method was also carried out. Alkaline treatment in 0.1 M solutions of NaOH or at 333 K for 30 min is preferred.

Various routes have been used to prepare the multimetallic zeolite catalysts:

Route 1. Hydrothermal Synthesis+Ion-Exchange

1.a. Hydrothermal Synthesis of Zeolites Without Iron

Six series of MFI-structure molecular sieves were prepared by hydrothermal synthesis, following the procedure described below. The main difference between these series is the composition of the framework, which can be varied by incorporation of different T-atoms in substitution of Si atoms: silicalite (pure silicate), Ti-silicalite, [Al]ZSM-5 (aluminosilicate), [Ga]ZSM-5 (gallosilicate), [B]ZSM-5 (borosilicate) and [Ge,Al]ZSM-5 (germanoaluminosilicate). For every series (except for silicalite) samples with different molar Si/T ratio (ranging from 20 to 80) have been synthesized (T=B, Al, Ga, Ti). The amount of Ge in the last sample ranged from 0.1 to 1 wt. %.

The synthesis gel contained tetraethylorthosilicate (TEOS), tetrapropylammonium hydroxide (TPAOH), sodium hydroxide, aluminium nitrate nona-hydrated (only for [Al]ZSM-5 and [Ge,Al]ZSM-5), germanium dioxide (only for [Ge,Al]ZSM-5), gallium nitrate nona-hydrated (only for [Ga]ZSM-5), tetraethylortotitanate (TEOTi, only for Ti-silicalite) and boric acid or triethylorthoborate (only for [B]ZSM-5), in the following molar ratios: H₂O/Si=45; TPAOH/Si=0.1; NaOH/Si=0.2; Si/T=20-80 (T=Al, Ga, B, Ti); Ge=0.1-1 wt. %.

Zeolite synthesis. To prepare silicalite the silica source (TEOS) was added to the organic template (TPAOH) and sodium hydroxide with stirring. The resulting gelatinous mixture was kept at 333 K for 2 hours to remove the excess of ethanol formed due to hydrolysis of the TEOS. The gel was then placed into an autoclave with Teflon lining, and held in a static air oven at a constant temperature of 448 K for 5 days for hydrothermal synthesis. Once the synthesis was completed, the autoclave was cooled, and the crystalline material was separated by filtration and abundantly washed with distilled water. The white material was dried at 373 K overnight (as: as-synthesized sample).

Following a very similar preparation procedure to that described for [Al]ZSM-5 zeolite, [Al]beta zeolite was also synthesized. In this case, TEAOH was used as the template instead of TPAOH. The crystallization of [Al]beta was 8 days at 415 K. This has been further elaborated in one of the examples of the patent.

Zeolite activation or post-synthesis treatments. The dried solid was calcined in flowing air at 823 K during 10 hours to burn out the template. The samples were converted into the proton-form by three consecutive exchanges with an ammonium nitrate solution (0.1 M) overnight and subsequent calcination at 823 K for 5 hours (c: calcined sample). Later on, the samples were treated with water vapour at high temperature (s: steamed sample). This process was carried out at different temperatures (623-1273 K), different water content (3-100 vol. % H₂O), different total flow (from about 3 to 300 ml inert gas (STP) min⁻¹) and duration (0.5-6 h). Finally, the samples were treated in alkaline media (preferably NaOH, but also KOH and NH₄OH) with a concentration of 0.1-1.0 M at 310-370 K for 10-60 min (preferred conditions 0.1 M solution, 353 K, 30 min). The slurry was then cooled down immediately using an ice bath, filtered, rinsed at 353 K with distilled water, and dried at 383 K (a: alkaline-treated sample).

A similar method was used to prepare Ti-silicalite. In this case TEOTl was added drop-wise to the TEOS solution while stirring. This produced a yellow solution of silicon and titanium alcoxides that was kept at room temperature for 2 hours. This solution was added to the TPAOH and NaOH solution with continuous stirring. The as-synthesized, calcined, steamed and alkaline-treated sample of Ti-silicalite was obtained by following the general procedure above-mentioned.

For the [T]ZSM-5 samples (T=B, Al, Ga), a solution containing TEOS, TPAOH, and NaOH (solution A) was added drop-wise to the corresponding boron, aluminium or gallium solution (solution B). The final solution was kept at 333 K 2 hours to remove the excess ethanol formed. The general method described for silicalite was followed to obtain the as-synthesized, calcined, steamed and alkaline-treated [T]ZSM-5 zeolites. In order to prepare samples with different molar Si/T ratios (T=B, Al, Ga) the amount of the boric acid or triethylorthoborate, aluminum nitrate and gallium nitrate was adjusted to obtain values in the range of 20-80.

The zeolites containing Ge and Al were prepared by adapting the method described for [Al]ZSM-5. The required amount of GeO₂ was added to the TEOS/TPAOH/NaOH solution. The resulting gelatinous mixture was added drop-wise to solution B (aluminium nitrate) and the general procedure followed to obtain the as-synthesized, calcined, steamed, and alkaline-treated samples. Samples with a molar Si/Al ratio ranging from 20 to 80 and a Ge content ranging from 0.1 to 1 wt. % were prepared.

1.b. Hydrothermal Synthesis of Zeolites With Iron

In order to incorporate iron in the zeolites we have used the same method as described in section 1.a. For every sample of the six series described in 1.a, the corresponding iron molecular sieve has been synthesized. This preferably requires the use of iron(III) nitrate nona-hydrated as the source of iron (but iron acetate, chloride, carbonate, and sulfate can be also used). In all cases e.g. iron nitrate was dissolved in solution B, and solution A was added drop-wise to solution B. The same procedure described above to activate the as-synthesized zeolites (calcination, steam treatment, and alkaline treatment) was applied.

1.c. Incorporation of a Second, Third, or any Additional Transition Metal in Zeolites With Iron

A similar method that described in section 1.b was used to prepare iron-containing molecular sieves modified by the introduction of a second transition metal via ion exchange. In this case, after the ammonium exchange (and before the calcination to decompose the ammonium ion into the protonic form), the samples were exchanged with a second transition metal. All the iron-containing samples ([Fe]-silicalite, [Fe,Ti]-silicalite, [Fe,Al]ZSM-5, [Fe,Ga]ZSM-5, [Fe,B]ZSM-5, and [Fe,Ge,Al]ZSM-5) were exchanged with different loading with a second transition metal (Co, Cu, Ni, Mn, Cr, and V).

The introduction of the second transition metal ion was performed via liquid or solid-ion exchange. In the liquid ion-exchange method, a 0.1 M water solution of the corresponding salt (nitrates, sulphates, chlorides, carbonates, and acetates) was used in order to obtain a metal loading of the second transition metal ranging from about 0.1 to 1 wt. %.

A solid ion-exchange method was also used to incorporate the second transition metal in the formulation. For that purpose, the calcined iron molecular sieve was physically mixed with adequate amounts of the metal precursor (preferably chloride).

The products of the ion-exchange method were calcined, steam activated, and alkaline treated as described in section 1.a.

Provided that most of the metals used have different oxidation states, in the cases it was possible, we have performed the ion exchange starting from salts with different oxidation state of the transition metals.

Route 2. Simultaneous or Consecutive Ion-Exchange

Samples prepared as described in section 1.a were subjected to simultaneous or consecutive liquid and solid ion-exchange technique. In simultaneous ion-exchange, the introduction of the iron and the second, third, or any additional transition metal ion was simultaneously performed via liquid or solid-ion exchanged, while in the consecutive method iron ion-exchange is followed by the ion-exchange of a second, third, or any additional transition metal. All the samples included in the series of six catalysts (silicalite, [Ti]silicalite, [Al]ZSM-5, [Ga]ZSM-5, [B]ZSM-5 and [Ge,Al]ZSM-5) were ion exchanged.

After the ammonium-exchange and before the calcination to decompose the ammonium ion and obtain the protonic form, the samples were ion exchanged with a mixture of an iron salt (nitrate, sulphate, chloride, carbonate, or acetate) and a salt (nitrate, sulphate, chloride, carbonate, or acetate) of a second transition metal (cobalt, copper, chromium, vanadium, manganese and nickel).

In the liquid-ion exchange method, an 0.1 M (for all metals) aqueous solution of the corresponding salts (nitrates, sulphates, chlorides, carbonates and acetates) was used, being the objective to obtain a metal loading for every transition metal ranging from 0.1 to 1 wt. % of each metal in the final formulation. In the solid-ion exchanged method, the corresponding amount of every salt was used in order to get a metal loading ranging from 0.1 to 1.0 wt. % of each metal in the final formulation. Salts of the metals with different oxidation states were used whenever possible.

As described in section 1.a, the ion-exchanged samples were calcined, steam activated, and finally alkaline treated.

Route 3. Hydrothermal Synthesis+Impregnation

Samples prepared in the manner of section 1.b were subjected to impregnation process in order to introduce the second transition metal. After the ammonium exchange and before the calcination to decompose the ammonium ion and obtain the proton form, the samples were impregnated with a second transition metal solution. Every one of the iron samples included in the six series ([Fe]-silicalite, [Fe,Ti]-silicalite, [Fe,Al]ZSM-5, [Fe,Ga]ZSM-5, [Fe,B]ZSM-5, and [Fe,Ge,Al]ZSM-5) was impregnated with a second transition metal (cobalt, copper, chromium, vanadium, manganese, and nickel).

The introduction of the second transition metal ion was performed via incipient wetness, using in every case a water solution of the corresponding salt (nitrate, sulphate, chloride, carbonate, or acetate). These solutions were prepared with the water volume required to fill the pore volume of the sample and the required amount of the metal salt in order to get to desired metal loading (from about 0.1 to 1 wt. %). As mentioned in section 1.c, in the cases it was possible, we performed the impregnation starting from salts with different oxidation state of the transition metals.

As described in section 1.a, the impregnated samples were calcined, activated by steam, and finally alkaline treated.

Route 4. Simultaneous or Consecutive Impregnation

Samples prepared in the manner of section la were subjected to simultaneous or consecutive impregnation (incipient wetness) method. In the simultaneous method, both iron and the second, third, or any additional transition metal ion were loaded simultaneously, while in the consecutive method iron impregnation is followed by the impregnation of the second, third, or any additional transition metal.

After the ammonium exchange and before the calcination to decompose the ammonium ion and obtain the proton form, the samples were impregnated with a solution mixture of an iron salt (nitrate, sulphate, chloride, carbonate, or acetate) and a salt (nitrate, sulphate, chloride, carbonate, and acetate) of a second transition metal (cobalt, copper, chromium, vanadium, manganese and nickel). Every samples included in the six series (silicalite, [Ti]silicalite, [Al]ZSM-5, [Ga]ZSM-5, [B]ZSM-5, or [Ge,Al]ZSM-5) was impregnated.

The introduction of the transition metal ions was performed via impregnation (incipient wetness), using in every case a water solution of the corresponding salts. These solutions were prepared with the water volume required to fill the pore volume of the sample and the required amount of the metal salts in order to get to desired metal loading for each metal (from about 0.1 to 1 wt. %). As mentioned in section 1.c, in the cases it was possible, we performed the impregnation starting from salts with different oxidation state of the transition metals.

As described in section 1.a, the simultaneously impregnated samples were calcined, activated by steam, and finally alkaline treated.

The prepared samples have been tested both in lab-scale and pilot-scale.

Activity Tests In Lab-Scale

Activity and stability measurements were carried out in a parallel-flow reactor system, using 50 mg of catalyst (300-400 μm) and a gas-hourly space velocity (GHSV) of 60,000 h⁻¹ at a total pressure of 5 bar. The catalyst performance in different feed mixtures was tested. Partial pressures of the reactants were 6.5 mbar N₂O, 150 mbar O₂, 10. mbar NOₓ, 75 mbar H₂O, 0.25 mbar CO, 0.25 mbar SO₂, and 6.5 mbar C₃H₆, using helium as balance gas. Before reaction, the catalysts were pre-treated in the corresponding feed mixture at 723 K for 1 hour and cooled in that gas flow to the initial reaction temperature. Reaction products were analyzed by gas chromatograph (N₂O, N₂, O₂, C₃H₆, CO, CO₂) and chemiluminescence analyzer (NO, NO₂, NOₓ).

Preparation and Activity of the Monolithic Catalysts

Laboratory screening is carried out with catalyst pellets. Small particles normally do not apply in conventional industrial fixed-bed reactor because of the high-pressure drop. The practical form and the shape of the catalyst is a crucial aspect to obtain reliable design data for full-scale implementation. Therefore, a structured monolithic reactor coated with the bimetallic zeolite catalyst was prepared and tested in pilot scale.

Applying the zeolite crystals by a dip-coating technique results in a coating consisting of randomly oriented zeolite crystal layers useful for adsorption and catalysis purposes. The support is immersed in a suspension of the zeolite crystals in a solvent containing a binder and other additives followed by evaporation of the solvent by drying and calcination.

The invention will be further illustrated by the following examples showing further preparation of samples and catalytic testing of the samples.

### EXAMPLE 1

Preparation of [Fe—Al]MFI

To prepare [Fe—Al]MFI with a molar Si/Al ratio of 50 and 0.5 wt. % Fe, TEOS as Si source, aluminium and iron nitrate as source of Al and Fe respectively and TPAOH as template were used. 20.83 g of TEOS (0.1 mol) was added drop-wise to a mixture of 0.8 g of NaOH (0.02 mol), 10.169 g of TPAOH (20% water solution) and 67.115 g of distilled water while stirring. Solution A, while stirring, was added drop-wise to the iron and aluminium nitrates solution (solution B) prepared by dissolving 0.750 g of Al(NO₃)₃.9H₂O (2.0 mmol) and 0.235 g of Fe(NO₃)₃.9H₂O (0.58 mmol) in 12.95 g of water. The final solution was kept at 333 K for 2 hours to remove the excess of ethanol formed due to hydrolysis of the TEOS. The gel was then placed into an autoclave with Teflon lining, and held in a static air oven at a constant temperature of 448 K for 5 days for hydrothermal synthesis. Once the synthesis was completed, the autoclave was cooled, and the crystalline material was separated by filtration and abundantly washed with distilled water. The as-synthesized zeolite was dried at 373 K overnight.

### EXAMPLE 2

Preparation of [Fe—Al]BEA

To prepare [Fe—Al]BEA with a Si/Al=50 (molar ratio) and 0.5 wt. % Fe, TEOS as Si source, aluminium and iron nitrate as source of Al and Fe respectively and TEAOH as template were used. 20.83 g of TEOS (0.1 mol) were added drop-wise to a mixture of 0.4 g of NaOH (0.01 mol), 29.4 g of TEAOH (20% water solution) and 9.68 g of distilled water while stirring. Solution A, while stirring, was added drop-wise to the iron and aluminium nitrates solution (solution B) prepared by dissolving 0.750 g of Al(NO₃)₃.9H₂O (2.0 mmol) and 0.235 g of Fe(NO₃)₃.9H₂O (0.58 mmol) in 1.0 g of water. The final solution was kept at 333 K 2 hours to remove the excess of ethanol formed due to hydrolysis of the TEOS. The gel was then placed into an autoclave with Teflon lining, and held in a static air oven at a constant temperature of 415 K for 8 days for hydrothermal synthesis. Once the synthesis was completed, the autoclave was cooled, and the crystalline material was separated by filtration and abundantly washed with distilled water. The as-synthesized material was dried at 348 K overnight.

### EXAMPLE 3

Preparation of Zeolites With Different Framework Compositions

Zeolite catalysts with framework of different compositions were prepared substantially in the manner of Example 1. This was done by varying the T atom in [Fe,T]MFI. In Examples 1 and 2, T=Al, but it can also be Ga, B, Ti, Ge, or without any T atom in the structure. For a molar Si/T ratio of 50, the following amounts of T precursors were added in the synthesis gel (solution B):
[Fe—Ga]MFI: 0.835 g of Ga(NO₃)₃.9H₂O (2 mmol)
[Fe—B]MFI: 0.124 g of boric acid (2 mmol)

0.292 g of triethylortoborate (2 mmol)
[Fe—Ti]MFI: 0.456 g of tetraethylortotitanate (2 mmol) or
[Fe]MFI: excluding the T atom precursor in the synthesis gel

### EXAMPLE 4

Activation of Fe-Zeolite Catalysts

The activation of the dried sample prepared in Examples 1, 2, and 3 started with calcination in flowing air at 823 K during 10 hours to burn-off the template. The sample was then converted into the H-form by three consecutive liquid-ion exchanges with an ammonium nitrate solution (0.1 M) overnight and subsequent air calcination at 823 K for 5 h. Then the samples were treated:
In vacuum, at temperatures of 1073-1173 K, during 5 h, or
In steam, at temperatures of 623-1273 K, water steam content of 3-100 vol. %, and a total flow of 3-300 ml inert gas (STP) min⁻¹ and duration 0.5-6 hours.

Finally, the samples activated via the above procedures were treated in alkaline solution at temperatures of 298-363 K for 10-60 min in aqueous solutions 0.1-1.0 M of NaOH, KOH, NH₄OH solutions. The slurry was then cooled down immediately using an ice bath, filtered, rinsed at 353 K with distilled water, and dried at 383 K.

### EXAMPLE 5

Preparation of Multimetallic Fe—Co, Fe—Cu and Fe—Co—Cu Zeolites

Catalyst prepared substantially in the manner of Examples 1, 2, and 3 was, after the ammonium exchange and before calcination, subjected to liquid ion exchange with Co(CH₃CO₂)₂.4H₂O and/or CuSO₄ (separately, simultaneously, or consecutively. The ion-exchange was performed with 0.1 M solutions. The pH during ion exchange was kept constant at ˜4 by adding diluted nitric acid. This process was repeated until a sample with approximately 0.5 wt. % of Co or Cu was obtained, or with approximately 0.25 wt. % Co and Cu (simultaneously, i.e. in the same solution or consecutively). After the exchange process, the samples were activated like described in Example 4, i.e. calcined, treated in vacuum or steam at high temperature and finally subjected to alkaline treatment.

### EXAMPLE 6

Tests in Lab-Scale of N₂O-Conversion for Different Zeolite Catalysts

Tests were performed in lab-scale for N₂O-conversion using various mono- and multimetallic MFI and BEA zeolites. The specific zeolites are given in FIG. 1a and b. The experimental conditions were as follows: 6.5 mbar N₂O, 150 mbar O₂, balance He; Total pressure=5 bar, GHSV=64,000 h⁻¹.

The samples were prepared and activated as described in Examples 1, 2, 3, and 4. N₂O conversion as function of temperature for MFI and BEA zeolites is shown in FIGS. 1a and b, respectively. Details of the tested zeolites are as follows: c=calcined at 823 K in air for 10 h, s=steam treated in 30 vol. % H₂O in N₂ at 873 K for 5 h, and a=alkaline treated in aqueous solutions of ammonium hydroxide (0.2 M) at 353 K for 0.5 h. The molar Si/Al ratio in the zeolites is 50. Metal loading in the catalysts: 0.5 wt. % of each metal. [ ] means metal introduced by isomorphous substitution (during hydrothermal synthesis) and ( ) means metal introduced by liquid ion-exchange method.

The most active catalysts, containing Fe and Co and/or Cu show complete conversion between 625 and 650 K in N₂O+O₂/He feed mixture. The conversion of N₂O over these multimetallic zeolites is higher than over monometallic zeolites. In e.g. MFI, combination of Co and Fe leads to 60 and 80 K lower operation temperatures with respect to the monometallic Co and Fe zeolites, respectively, for the same N₂O decomposition activity. The synergy between Co and Fe is more pronounced than between Cu and Fe, as can be concluded from the marked operation shift to lower temperatures. A physical mixture of the mono-metallic Co and Fe-zeolites give a very similar conversion as the most active of both zeolites, Co-zeolite, which indicates the chemical nature of the promotion. Similar trends were observed over BEA zeolites, achieving complete N₂O conversions at similar temperatures (625-650 K). This indicates a positive (synergetic) effect due to the combination of these specific metals in different zeolite types. Other catalysts prepared by the same method, where combinations of iron with a metal other than Co and/or Cu were used (e.g. transition metals like Ni, Cr, Mn, and V, or noble metals like Rh, Pd) showed no synergy effect, i.e. the activity is equal or lower than that of the corresponding monometallic zeolite.

This has been exemplified in FIG. 1a for the Ni—Fe system.

### EXAMPLE 7

Tests in Lab-Scale for N₂O-Conversion With Zeolites of Different Framework Composition

Tests were also performed for N₂O conversion using different framework compositions. The synergetic effect observed with combinations of Fe with Co and/or Cu was observed not only for different zeolite types as shown in Example 6, but also for the same zeolite type with different compositions. The experimental conditions were: 6.5 mbar N₂O, 150 mbar O₂, balance He; Temperature=623 K; Total pressure=5 bar, GHSV=64,000 h⁻¹.

FIG. 2 shows the N₂O conversion for bimetallic Co—Fe MFI zeolites with different framework compositions, whose preparation was described in Example 3. Details on the tested zeolites: c=calcined at 823 K in air for 10 h, s=steam treated in 45 vol. % H₂O in N₂ at different temperatures (in the figure) for 5 h, and a=alkaline treated in aqueous solutions of ammonium hydroxide (0.2 M) at 353 K for 0.5 h. The molar Si/T in the parent zeolites was 50. Metal loading in the catalysts: 0.5 wt. % of each metal (Co and Fe).

As can be concluded from the figure, similar activities can be obtained by optimising the temperature during steam activation treatment of the catalysts. Zeolite matrices with Brønsted acidity (Si—Al, Si—Ga) require a lower temperature to reach higher activities than slightly acidic (Si—B, Si—Al—Ge) or neutral zeolite matrices (Si, Si—Ti). A similar trend was observed for the bimetallic catalyst containing copper, and for the multi-metallic system containing Fe, Co, and Cu.

### EXAMPLE 8

Catalyst Performance Dependent on Preparation Method

Various MFI and BEA zeolites have been prepared using different methods and the catalytic performance has been tested. The occurrence of synergy for N₂O decomposition strongly depends on the preparation route. Tables 1 and 2 show an overview of zeolites prepared by different methods and their activity for N₂O decomposition. First of all, a proper activation of the synthesized iron-zeolite is essential to achieve superior activities for N₂O decomposition. Treatment in steam appears to be more effective than treatment in vacuum. The alkaline treatment further improves the activity of the catalysts. In order to have positive effect between metals in the final catalyst, iron should be introduced originally in the zeolite framework by hydrothermal synthesis, and the second metal (Co and/or Cu) should be introduced by liquid ion-exchange. Incorporation of the metals in the zeolite host should be followed by activation in vacuum or steam, and finally alkaline treatment. Following this optimal preparation, N₂O conversions >80% at ˜600 K in wet tail-gases have been achieved. Introduction of iron by liquid or solid-ion exchange, or incipient wetness lead to poor performances, and temperatures >700 K are required for high N₂O conversions. Introduction of the second metal (Co and Cu) by solid-ion exchange or incipient wetness also led to poor activities. The optimal method described above for MFI zeolites were applied over BEA zeolites. This structure leads to slightly higher activities than MFI.

TABLE 1
Influence of the preparation method on the catalyst performance
(N₂O conversion) over various MFI zeolites. Experimental
conditions: 6.5 mbar N₂O, 150 mbar O₂, 1.0 mbar NOₓ, 75 mbar
H₂O, balance He; Total pressure = 5 bar; GHSV = 64,000 h⁻¹.

| Catalyst | T/K | X(N₂O)/— |
|---|---|---|
| [Fe—Al]MFI(c)¹ | 800 | 0.32 |
| [Fe—Al]MFI(c, v)² | 700 | 0.68 |
| [Fe—Al]MFI(c, s)³ | 725 | 0.76 |
| [Fe—Al]MFI(c, s, a)⁴ | 715 | 0.83 |
| (Fe)[Al]MFI(c, s, a)⁵ | 735 | 0.59 |
| /Fe/[Al]MFI(c, s, a)⁷ | 750 | 0.36 |
| (Co)[Fe—Al]MFI(c) | 690 | 0.72 |
| (Co)[Fe—Al]MFI(c, s) | 600 | 0.85 |
| (Cu)[Fe—Al]MFI(c, s, a) | 602 | 0.94 |
| (Co)(Cu)[Fe—Al]MFI(c, s, a) | 610 | 0.81 |
| (Co, Cu)[Fe—Al]MFI(c, s, a) | 608 | 0.77 |
| (Co—Cu—Fe)[Al]MFI(c, s, a) | 720 | 0.56 |
| {Co}[Fe—Al]MFI(c, s, a) | 660 | 0.70 |
| {Cu}[Fe—Al]MFI(c, s, a) | 650 | 0.62 |
| /Co/Cu/[Fe—Al]MFI(c, s, a) | 745 | 0.70 |
| /Co, Cu, Fe/[Al]MFI(c, s, a) | 750 | 0.40 |
| /Co/[Fe—Al]MFI(c, s, a) | 740 | 0.62 |
| /Cu/[Fe—Al]MFI(c, s, a) | 735 | 0.66 |
| /Co—Cu—Fe/[Al]MFI(c, s, a) | 750 | 0.45 |

¹[ ] = metal introduced by hydrothermal synthesis (isomorphously substituted) and c = calcined at 823 K for 10 hours.
²v = activated in vacuum, 1173 K, 5 hours.
³s = activated in steam, 450 mbar H₂O in N₂, 873 K; 5 hours.
⁴a= activated in alkaline solution, NaOH, 0.1 M, 333 K; 30 min.
⁵(, ) or ( )( ) = metal introduced by a liquid ion-exchange method (simultaneous or consecutive).
⁶{, } or { }{ } = metal introduced by a solid ion-exchange method (simultaneous or consecutive).
⁷/, / or / // / = metal introduced by an incipient wetness method (simultaneous or consecutive).

TABLE 2
Influence of the preparation method on the catalyst performance
(N₂O conversion) over various BEA zeolites. Experimental
conditions: 6.5 mbar N₂O, 150 mbar O₂, 1.0 mbar NOₓ, 75 mbar
H₂O, balance He; Total pressure = 5 bar; GHSV = 64,000 h⁻¹.

| Catalyst | T/K | X(N₂O)/— |
|---|---|---|
| [Fe—Al]BEA(c) | 800 | 0.25 |
| [Fe—Al]BEA(c, v) | 700 | 0.70 |
| [Fe—Al] BEA(c, s) | 725 | 0.83 |
| (Co)[Fe—Al]BEA(c) | 650 | 0.60 |
| (Co)[Fe—Al]BEA(c, s) | 605 | 0.91 |
| (Cu)[Fe—Al] BEA(c, s, a) | 590 | 0.75 |
| (Co)(Cu)[Fe—Al] | 610 | 0.83 |
| BEA(c, s, a) | | |
| (Co, Cu)[Fe—Al] | 615 | 0.95 |
| BEA(c, s, a) | | |
| (Co—Cu—Fe)[Al] | 705 | 0.59 |
| BEA(c, s, a) | | |

### EXAMPLE 9

Catalyst Performance Dependent on Chemical Composition

Not only the preparation but also the chemical composition of the catalysts plays a role in the observed performance. Table 3 shows the conversion of N₂O at a certain temperature for zeolite samples with different chemical composition and metal loadings. Lower Si/Al ratios are favourable, as well as molar ratios iron/(cobalt+copper) close or equal to 1. In particular, samples with a molar Si/Al ratio of 50 in the as-synthesized material and 0.5 wt. % Fe and 0.5 wt. % Co (or 0.5 wt. % Cu) show a superior behaviour.

TABLE 3
N₂O conversion over mono- and multimetallic zeolites
with different compositions (Si/Al ratios) and metal loadings.
Experimental conditions: 6.5 mbar N₂O, 150 mbar O₂,
1.0 mbar NOₓ, 75 mbar H₂O, balance He;
Total pressure = 5 bar; GHSV = 64,000 h⁻¹.

| | Molar | Metal content/wt. % | | | | |
|---|---|---|---|---|---|---|
| Catalyst | Si/Al | Fe | Co | Cu | T/K | X(N₂O)/— |
| (Co)[Fe—Al]MFI(c, | 32 | 0.50 | 0.50 | — | 595 | 1.00 |
| s, a) | 50 | 0.50 | 0.50 | — | 610 | 0.92 |
| | 70 | 0.50 | 0.50 | — | 625 | 0.90 |
| | 32 | 0.10 | 0.50 | — | 680 | 0.70 |
| | 32 | 0.75 | 0.50 | — | 615 | 0.83 |
| | 32 | 1.00 | 0.50 | — | 610 | 0.80 |
| | 32 | 0.50 | 0.75 | — | 612 | 0.89 |
| | 32 | 0.50 | 1.00 | — | 620 | 0.86 |
| | 32 | 0.50 | 1.50 | — | 620 | 0.69 |
| (Cu)[Fe—Al]MFI(c, | 32 | 0.50 | — | 0.50 | 630 | 0.93 |
| s, a) | 50 | 0.50 | — | 0.50 | 641 | 0.85 |
| | 70 | 0.50 | — | 0.50 | 642 | 0.78 |
| | 32 | 0.10 | — | 0.50 | 691 | 0.64 |
| | 32 | 0.75 | — | 0.50 | 650 | 0.73 |
| | 32 | 1.00 | — | 0.50 | 639 | 0.80 |
| | 32 | 0.50 | — | 0.75 | 612 | 0.89 |
| | 32 | 0.50 | — | 1.00 | 658 | 0.76 |
| | 32 | 0.50 | — | 1.50 | 675 | 0.69 |

### EXAMPLE 10

Performance of Multimetallic Zeolites in Different Feed-Gas Mixtures

The performance of the most promising catalyst has been evaluated in different feed compositions, simulating tail-gas applications of different nature. The results are collected in Table 4. The effects of addition of propene, carbon monoxide, and sulfur dioxide over promising bimetallic catalysts were investigated. Addition of reductants (C₃H₆, CO) led to a lower operation temperature of the samples (compare columns B and C with A). SO₂, a typical component in tail-gases from combustion processes, leads to higher operation temperatures. Depending on the specific applications, operations temperatures ranging from 600-800 K lead to highly active systems. The bimetallic catalyst containing Cu and Fe is somehow inhibited by the presence of propene, while the bimetallic catalyst containing Co and Fe further reduces its operation temperature. A similar positive effect was observed by addition of CO. The presence of SO₂ shifts the decomposition reaction to higher temperatures.

TABLE 4
Performance of multimetallic zeolites at different experimental conditions (see footnote).

| | A | | B | | C | | D | |
|---|---|---|---|---|---|---|---|---|
| Catalyst | T/K | X(N₂O)/— | T/K | X(N₂O)/— | T/K | X(N₂O)/— | T/K | X(N₂O)/— |
| (Co)[Fe—Al]MFI(c, s, a) | 610 | 0.95 | 562 | 0.90 | 551 | 0.88 | 685 | 0.83 |
| (Co)[Fe—Al]BEA(c, s, a) | 598 | 0.92 | 543 | 0.95 | 540 | 0.80 | 660 | 0.80 |
| (Cu)[Fe—Al]MFI(c, s, a) | 632 | 0.95 | 663 | 0.90 | 589 | 0.86 | 695 | 0.72 |
| (Cu)[Fe—Al]BEA(c, s, a) | 638 | 0.91 | 658 | 0.92 | 594 | 0.90 | 703 | 0.78 |

Experimental conditions:
A: 6.5 mbar N₂O, 150 mbar O₂, 1.0 mbar NOₓ, 75 mbar H₂O, balance He.
B: 6.5 mbar N₂O, 150 mbar O₂, 1.0 mbar NOₓ, 75 mbar H₂O, 6.5 mbar C₃H₆, balance He.
C: 6.5 mbar N₂O, 150 mbar O₂, 1.0 mbar NOₓ, 75 mbar H₂O, 0.25 mbar CO, balance He.
D: 6.5 mbar N₂O, 150 mbar O₂, 1.0 mbar NOₓ, 75 mbar H₂O, 0.25 mbar SO₂, balance He.
In all cases: Total pressure = 5 bar, Space velocity = 75,000 h⁻¹.

### EXAMPLE 11

Preparation of Monolithic Catalysts for Pilot-Plant Tests

Monolithic catalysts for pilot-plant tests were prepared by dip-coating. Cordierite (2Al₂O₃.5SiO₂.2MgO) was used as the support. The diameter and length of the monolith used for coating experiments was 25 cm and 10 cm, respectively. The cell density of the monolithic structure was 200 cpsi (wall thickness 0.3 mm and channel diameter 1.49 mm). The pretreatment of the cordierite substrate was done by calcining the structure at 1273 K during 3 hours to remove any contamination from the support. Dip-coating the monolith with (Co)[Fe—Al]MFI(c,s,a) was performed by preparing a mixture of the catalyst powder, a solvent (butyl acetate, 10-20 wt. %), a binder (colloidal silica (Ludox AS-40, a 40 wt. % suspension of colloidal silica in water), and a surfactant (Teepol). As a temporary binder, 1.2 g nitrocellulose, moistened with 35% ethanol, was added to the mixture for binding of the zeolite crystals before calcination. To obtain a homogeneously dispersed mixture, the slurry was well mixed with a high-shear mixer for 1 min at 13000 rpm. Next the monoliths were dipped into the mixture for 3 min. Excess liquid was removed with pressurized air. After drying the zeolite dip-coated monoliths for one night at room temperature, while rotating in a horizontal position, the monoliths were dried in air by increasing the temperature by 1 K per minute to 473 K, and calcined at 673 K (heating rate 10 K per minute).

### EXAMPLE 12

Pilot Scale Tests

The performance of monolithic catalysts in pilot scale was tested. The conversion over the catalyst (Co)[Fe—Al]MFI(c,s,a) was stable in time-on-stream experiments during >2000 hours in tail-gases containing N₂O, O₂, NO, and H₂O at 630 K. This is illustrated in FIG. 3.

Experimental conditions: 6.5 mbar N₂O, 150 mbar O₂, 1.0 mbar NOₓ, 75 mbar H₂O, balance He; Temperature=630 K; Total pressure=5 bar; Pilot scale: total volumetric flow=220 m³ per hour; reactor volume=5.9 litres. Details on the tested zeolites: c=calcined at 823 K in air for 10 h, s=steam treated in 45 vol. % H₂O in N₂ at different temperatures (in the figure) for 5 h, and a=alkaline treated in aqueous solutions of ammonium hydroxide (0.2 M) at 353 K for 0.5 h. The molar Si/Al in the parent zeolite was 50. Metal loading in the catalysts: 0.5 wt. % of each metal (Co and Fe).

It was thus found that the synthesis route strongly influences the performance of the final catalyst. The optimal incorporation of the metals in the zeolite involves isomorphous substitution of iron in the zeolite framework and liquid or solid-ion exchange of the other metals. The other synthesis routes attempted have produced lower performances in the reaction.

The experiments show that multi-metallic Co—Fe, Cu—Fe and Co—Cu—Fe zeolite catalysts have shown a synergetic effect in catalyzed N₂O decomposition, with a decreased operation temperature compared to the corresponding monometallic zeolites. This improved activity is caused by the presence of Fe—Co or Fe—Cu-oxo nano-clusters in the zeolite channels. The particular structure and concentration of these clusters, where both metals are in close proximity via oxygen bridges, is determined by the novel preparation method described in this invention. Other catalysts with a combination of Fe—Ni, and Fe—Mn do not show this synergy, which suggests the affinity of Cu or Co with Fe.

Activation of the catalysts by steam and alkaline treatment is essential to generate these particular clusters, and thus to produce such active and stable catalytic systems for N₂O decomposition in tail-gases from various processes. This novel aspect is highly relevant in practical applications.

1. Method for production of a multimetallic zeolite catalyst, wherein Fe is introduced by isomorphous substitution in a zeolite framework by hydrothermal synthesis, whereafter the zeolite is calcined and converted into H-form, whereafter Cu and/or Co is introduced by liquid or solid-ion exchange before the product is calcined, activated at high temperature (>1073 k) or by steam and subjected to an alkaline treatment:

2. A method according to claim 1, wherein the zeolite catalyst has a structure analogous to MFI and/or BEA.

3. Method according to claim 1, wherein the zeolite used is [Al]-ZSM-5, [Al]-BEA, [Ga]-ZSM-5, [B]-ZSM-5, [Al,Ge]-ZSM-5, silicalite or [Ti]-silicalite.

4. Method according to claim 3, wherein Si/T is 20-80 (molar ratio) and T=Al, Ga, B, Ge or Ti.

5. Method according to claim 1, wherein the iron content introduced in the materials ranges from 0.1-1.0 wt. % Fe.

6. Method according to claim 1, wherein the content of Cu and/or Co introduced ranges from 0.1-1.0 wt. %.

7. Method according to claim 1, wherein the zeolite produced is a Fe—Co or Fe—Cu or Fe—Co—Cu zeolite.

8. Method according to claim 1, wherein the ratio Fe/Co, Fe/Cu or Fe/Co+Cu≈1.

9. Method according to claim 1, wherein one or more of the elements Mn, V, Ni or Cr is introduced into the zeolite in addition to Co and/or Cu.

10. Method according to claim 1, wherein Cu or Co is introduced by liquid or solid ion exchange.

11. Method according to claim 1, wherein the activation is carried out with water vapour at 623-1273 K, 3-100 vol. % H₂O, at 3-300 ml inert gas (STP) min⁻¹ and time-on-stream 0.5-6 h.

12. Method according to claim 1, wherein the activation is carried out in vacuum or air gas at temperatures above 1073 K.

13. Method according to claim 1, wherein the alkaline treatment is carried out in alkaline media (NaOH, KOH, or NH₄OH) for 0.5-3 hours.

14. Use of a multi-metallic zeolite produced according to claim 1, for direct catalytic decomposition of N₂O.

15. Method for decomposition or reduction of nitrous oxide at temperatures below 650 K in tail-gases by use of a zeolite with the general formula:
x·T₂Oₚ-y·Fe₂O₃-z·M₂O_{q}-SiO₂
wherein:
x=0-0.065
y=0.00002-0.02
z=0.00002-0.02
T=Al, Ga, B, Ge or Ti
p=valence of the T element
M=Cu, Co, Mn, V, Ni, Cr
q=valence of the M element

16. Method according to claim 15, wherein a zeolite is used wherein M=Cu and/ Co.

17. A zeolite catalyst with the general formula:
x·T₂Oₚ-y·Fe₂O₃-z·M₂O_{q}-SiO₂
wherein:
x=0-0.065
y=0.00002-0.02
z=0.00002-0.02
T=Al, Ga, B, Ge or Ti
p=valence of the T element
M=Cu, Co, Mn, V, Ni, Cr
q=valence of the M element

18. A zeolite catalyst according to claim 17, wherein M=Cu and/or Co.

19. Method according to claim 2, wherein the zeolite used is [Al]-ZSM-5, [Al]-BEA, [Ga]-ZSM-5, [B]-ZSM-5, [Al,Ge]-ZSM-5, silicalite or [Ti]-silicalite.

20. Method according to claim 2, wherein the ratio Fe/Co, Fe/Cu or Fe/Co+Cu≈1.

21. Method according to claim 3, wherein the ratio Fe/Co, Fe/Cu or Fe/Co+Cu≈1.

22. Method according to claim 4, wherein the ratio Fe/Co, Fe/Cu or Fe/Co+Cu≈1.

23. Method according to claim 5, wherein the ratio Fe/Co, Fe/Cu or Fe/Co+Cu≈1.

24. Method according to claim 6, wherein the ratio Fe/Co, Fe/Cu or Fe/Co+Cu≈1.

25. Method according to claim 7, wherein the ratio Fe/Co, Fe/Cu or Fe/Co+Cu≈1.

26. Method according to claim 2, wherein one or more of the elements Mn, V, Ni or Cr is introduced into the zeolite in addition to Co and/or Cu.

27. Method according to claim 3, wherein one or more of the elements Mn, V, Ni or Cr is introduced into the zeolite in addition to Co and/or Cu.

28. Method according to claim 4, wherein one or more of the elements Mn, V, Ni or Cr is introduced into the zeolite in addition to Co and/or Cu.

29. Method according to claim 5, wherein one or more of the elements Mn, V, Ni or Cr is introduced into the zeolite in addition to Co and/or Cu.

30. Method according to claim 6, wherein one or more of the elements Mn, V, Ni or Cr is introduced into the zeolite in addition to Co and/or Cu.

31. Method according to claim 7, wherein one or more of the elements Mn, V, Ni or Cr is introduced into the zeolite in addition to Co and/or Cu.

32. Method according to claim 8, wherein one or more of the elements Mn, V, Ni or Cr is introduced into the zeolite in addition to Co and/or Cu.
